(19) United States
(12) Patent Application Publication
(10) Pub. No.: US 2006/0182376 A1
(43) Pub. Date: Aug. 17, 2006

(54) Hybrid skate bearing

(76) Inventor: Scott Burwell, Aliso Viejo, CA (US)

Correspondence Address: CROCKETT & CROCKETT, 24012 CALLE DE LA PLATA, SUITE 400, LAGUNA HILLS, CA, 92653, US

(21) Appl. No.: 11/315,441

(22) Filed: Dec. 21, 2005

Related U.S. Application Data
(60) Provisional application No. 60/593,841, filed on Feb. 17, 2005.

(51) Int. Cl. F16C 33/62

(52) U.S. Cl. 384/492

(57) ABSTRACT

A hybrid roller bearing according to the present disclosure combines at least one ceramic ball bearing and steel ball bearings to form a complete roller bearing. The use of less than a complete set of ceramic balls in a single bearing may offer many of the benefits of a full ceramic bearing at a lower cost. Ceramic ball bearings provide lower rolling friction than steel balls and generally remain cleaner and require less lubrication.

### RELATED APPLICATIONS

This application claims priority from U.S. Provisional Patent Application 60/593,841 filed Feb. 17, 2005.

### FIELD OF THE INVENTIONS

The inventions described below relate the field of roller bearings and more specifically to the field of ceramic and steel roller bearings for skateboards.

### BACKGROUND OF THE INVENTIONS

Roller bearings have been a conventional tool in our effort to approach frictionless movement. Early roller bearings encountered problems with soft materials and lubrication. As materials science technology has improved, roller bearings are better than in the past.

The introduction of ceramics into the world of roller bearings has improved the tolerances of bearings as well as their resistance to wear with less lubrication. Ceramic bearings are also expensive. What is needed is a hybrid bearing providing many of the benefits of ceramic bearings with less cost.

### SUMMARY

A hybrid roller bearing according to the present disclosure combines at least one ceramic ball bearing and steel ball bearings to form a complete roller bearing. The use of less than a complete set of ceramic balls in a single bearing may offer many of the benefits of a full ceramic bearing at a lower cost. Ceramic ball bearings provide lower rolling friction than steel balls and generally remain cleaner and require less lubrication.

In another aspect of the present disclosure, steel and ceramic ball bearings may be provided in any suitable proportion in a single hybrid bearing. For example, in a six ball bearing there may be 1 ceramic ball bearing and 5 steel ball bearings, or 2 ceramic ball bearings and 4 steel ball bearings, or 3 ceramic ball bearings and 3 steel ball bearings, or 4 ceramic ball bearings and 2 steel ball bearings, or 5 ceramic ball bearings and 1 steel ball bearing.

A hybrid bearing according to the present disclosure includes a generally circular outer race, a generally circular inner race, the inner race concentric with the outer race, six or more bearing elements engaged between the inner race and the outer race, at least one bearing element composed of ceramic and at least one bearing element composed of steel, and means for maintaining uniform separation between the bearing elements.

### BRIEF DESCRIPTION OF THE DRAWINGS

FIG. 1 is a front view of a seven ball bearing according to the present disclosure.

FIG. 2 is a front view of a six ball bearing according to the present disclosure.

FIG. 3 is a cross-section of the six ball bearing of FIG. 2 taken along line A-A.

FIG. 4 is a perspective view of a seven ball spacer according to the present disclosure.

FIG. 5 is a perspective view of a six ball spacer according to the present disclosure.

### DETAILED DESCRIPTION OF THE INVENTIONS

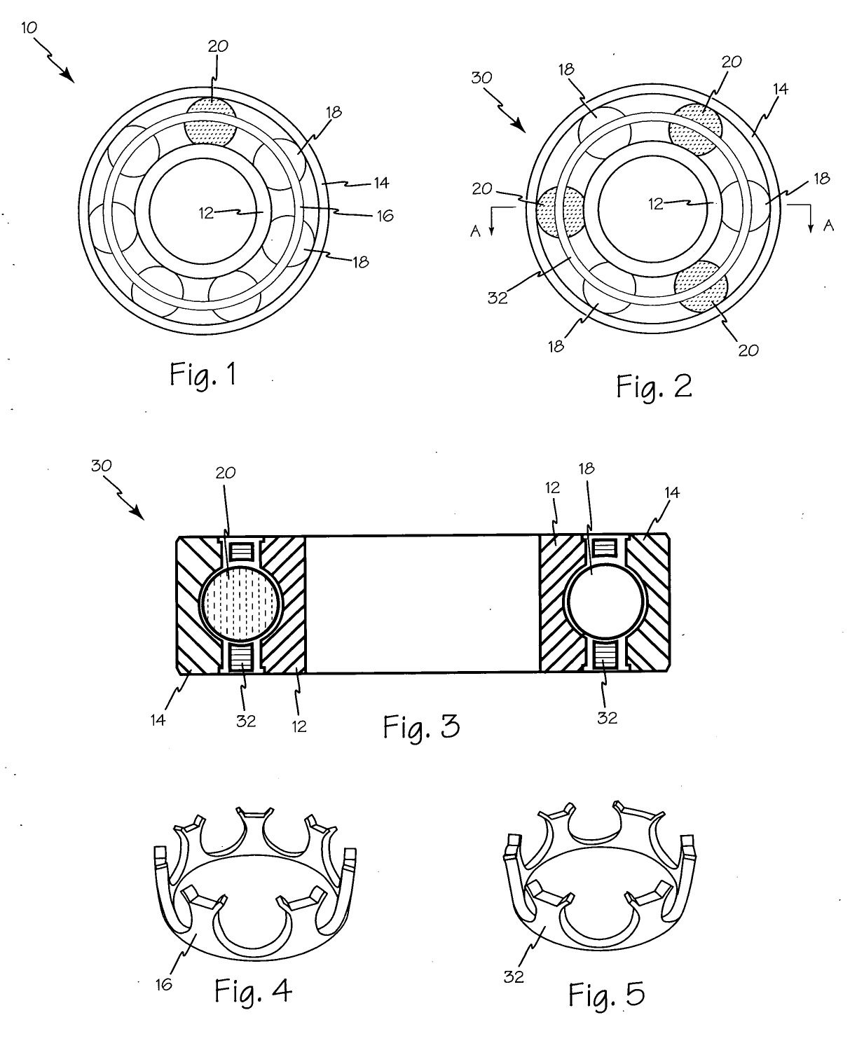

FIG. 1 illustrates hybrid bearing 10 that includes inner race 12, outer race 14, ball retainer 16 and seven ball bearings such as steel ball bearings 18, and or ceramic ball bearings 20. In a hybrid bearing according to the present disclosure at least one ceramic ball bearing is combined with one or more steel ball bearings. For example, in a 7-ball bearing such as bearing 10 there may be 1 ceramic ball bearing 20 and 6 steel ball bearings 18, or 2 ceramic ball bearings and 5 steel ball bearings, or 3 ceramic ball bearings and 4 steel ball bearings, or 4 ceramic ball bearings and 3 steel ball bearings, or 5 ceramic ball bearings and 2 steel ball bearings, or 6 ceramic ball bearings and 1 steel ball bearing.

Referring now to FIG. 2 hybrid bearing 30 is a 6-ball hybrid bearing similar to hybrid bearing 10. Hybrid bearing 30 includes inner race 12, outer race 14, ball retainer 32 and 6 ball bearings with at least one ceramic ball bearing 20 and at least one steel ball bearing 18 and any suitable combination of steel and ceramic ball bearings for the remaining four ball bearings. Inner race 12 and outer race 14 may be made of any suitable material, and may include any suitable surface treatments or coatings.

Referring now to FIG. 3, the ball bearings such as ceramic ball bearing 20 and steel ball bearing 18 are engaged between inner race 12 and outer race 14 of hybrid bearing 30. The relative positions of the ball bearings of a roller bearing such as hybrid bearing 10 or hybrid bearing 30 may be maintained by a suitable ball retainer such as ball retainers 16 or 32.

Referring now to FIGS. 4 and 5, ball retainers 16 and 32 maintain a generally uniform separation between adjacent bearing elements such as ceramic ball bearings 20 and steel ball bearings 18. Ball retainers 32 and 16 may be made from any suitable material such as for example plastic, metal, nylon or any other.

The present disclosure is focused on roller bearing having 6 or 7 ball bearings engaged between the inner and outer races. More or fewer ball bearings may also be used. Additionally the present disclosure may also be applied to conical bearings and bearing with linear roller elements instead of balls.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A hybrid bearing comprising:
a generally circular outer race;
a generally circular inner race, the inner race concentric with the outer race;
six or more bearing elements engaged between the inner race and the outer race, at least one bearing element composed of ceramic and at least one bearing element composed of steel; and
means for maintaining uniform separation between the bearing elements.

2. The hybrid bearing of claim 1 wherein the six or more bearing elements are 1 steel ball bearing and 5 ceramic ball bearings.

3. The hybrid bearing of claim 1 wherein the six or more bearing elements are 2 steel ball bearings and 4 ceramic ball bearings.

4. The hybrid bearing of claim 1 wherein the six or more bearing elements are 3 steel ball bearings and 3 ceramic ball bearings.

5. The hybrid bearing of claim 1 wherein the six or more bearing elements are 4 steel ball bearings and 2 ceramic ball bearings.

6. The hybrid bearing of claim 1 wherein the six or more bearing elements are 5 steel ball bearings and 1 ceramic ball bearing.

7. The hybrid bearing of claim 1 wherein the six or more bearing elements are 1 steel ball bearing and 6 ceramic ball bearings.

8. The hybrid bearing of claim 1 wherein the six or more bearing elements are 2 steel ball bearings and 5 ceramic ball bearings.

9. The hybrid bearing of claim 1 wherein the six or more bearing elements are 3 steel ball bearings and 4 ceramic ball bearings.

10. The hybrid bearing of claim 1 wherein the six or more bearing elements are 4 steel ball bearings and 3 ceramic ball bearings.

11. The hybrid bearing of claim 1 wherein the six or more bearing elements are 5 steel ball bearings and 2 ceramic ball bearings.

12. The hybrid bearing of claim 1 wherein the six or more bearing elements are 6 steel ball bearings and 1 ceramic ball bearing.
